(19) United States
(12) Patent Application Publication
(10) Pub. No.: US 2003/0100337 A1
(43) Pub. Date: May 29, 2003

(54) Wireless device for broadcast of information and related method for use with mobile wireless devices

(76) Inventors: Gregory Chotkowski, New York, NY (US); J. Jeffrey Freda, Montclair, NJ (US)

Correspondence Address: DARA L ONOFRIO, ONOFRIO LAW, 1133 BROADWAY, SUITE 1600, NEW YORK, NY, 10010, US

(21) Appl. No.: 09/996,198

(22) Filed: Nov. 6, 2001

Related U.S. Application Data
(60) Provisional application No. 60/246,309, filed on Nov. 7, 2000.

(51) Int. Cl. H04M 3/42

(52) U.S. Cl. 455/556; 455/414; 455/412; 455/557

(57) ABSTRACT

A wireless device for broadcast of information comprising a medium; a means for storing information on said medium; and a means for transmitting the information on said medium to various access points including a desktop personal computer, a handheld computer, a cellular phone or other mobile wireless devices. A related system and method for broadcasting information from the wireless device is also included.

This application claims the benefit of U.S. provisional application No. 60/246,309 filed Nov. 7, 2000, which is incorporated herein by reference.

### FIELD OF THE INVENTION

The present invention relates to a wireless device for broadcast and dissemination of information. More particularly, it relates to an electronic system for providing automated wireless access of information to individuals using mobile wireless devices

### BACKGROUND OF THE INVENTION

Communication of certain information by merchants to customers, i.e. business cards, menus, flyers, coupons, advertisement and promotional information etc. by merchants to customers is inefficient and impractical because these items are easily lost, misplaced or discarded.

The invention overcomes this problem by providing a method and apparatus for making such information readily available to users of wireless cellphones and handheld computers (“handsets”) through a variety of media simultaneously including digital data and voice. The information may be broadcast wirelessly from a free standing broadcast device to personal portable devices or may be accessible through a dial up voice network.

The invention also provides a method and means for linking information captured on the portable device to an electronic network. This electronic network, among other things, is for consumers to store information about selected merchants and to match up offers and promotions from merchants to consumers and to facilitate various e-commerce activities.

Storing, receiving and accessing information according to the invention is easier than conventional print medium.

### SUMMARY OF THE INVENTION

The invention provides a wireless device for broadcast of information comprising a medium, a means for storing information on said medium and a means for transmitting the information on said medium to a mobile wireless device.

The broadcast device itself may have external or a self-contained power source. It may also have a fixed broadcast message or a means to be reprogrammed.

The invention also provides a single repository of information from which a business proprietor can disseminate a marketing/advertising message through various media. For example, an upcoming sales event could be logged into a central repository and then prepared by the system for access by a consumer through the Internet, or through digital broadcast from a wireless network to their handheld computer, or through an automated voice recording system. The information repository could be accessed and managed through an Internet, intranet or extranet interface.

Each digital broadcast device or automated voice system comprise a medium, a means for storing information on the medium and a means for transmitting the information on the medium to a mobile wireless device.

The automated voice recording system is actuated by a consumer by dialing a designated phone number and then following the voice prompts to get the desired information about a particular business or entity. Each participating business has its own unique identifier, e.g. dial the first three letters of the business name, and then custom created recorded messages about its products and services. One of the pre-recorded options is to connect the consumer directly to a store representative.

Other objects, features and advantages of the present invention will be apparent when the detailed description of the preferred embodiments of the invention are considered with reference to the drawings, which should be construed in an illustrative and not limiting sense as follows:

### BRIEF DESCRIPTION OF THE DRAWINGS

FIG. 1 illustrates current infrared “beaming”;

FIG. 2 illustrates a continuous infrared transmission device;

FIG. 3 illustrates a wireless device according to the invention;

FIG. 4 is a flow-chart diagram of the internet website home page which includes Consumers; Local area merchants; national retailers and business suppliers; and outlines the process steps according to the invention;

FIG. 5 is a flow-chart diagram of the Consumer process steps according to the invention;

FIG. 6 is a flow-chart diagram of the Local Area Merchant process steps according to the invention;

FIG. 7 is a flow-chart diagram of the National Retailer process steps according to the invention;

FIG. 8 is a flow-chart diagram of the Business Supplier process steps according to the invention;

FIG. 9 is a flow-chart diagram of the Administration process steps according to the invention;

FIG. 10 is a flow-chart diagram of the Virtual Message Board process steps according to the invention; and

FIG. 11 is an illustration of the Electronic Consumer identification page.

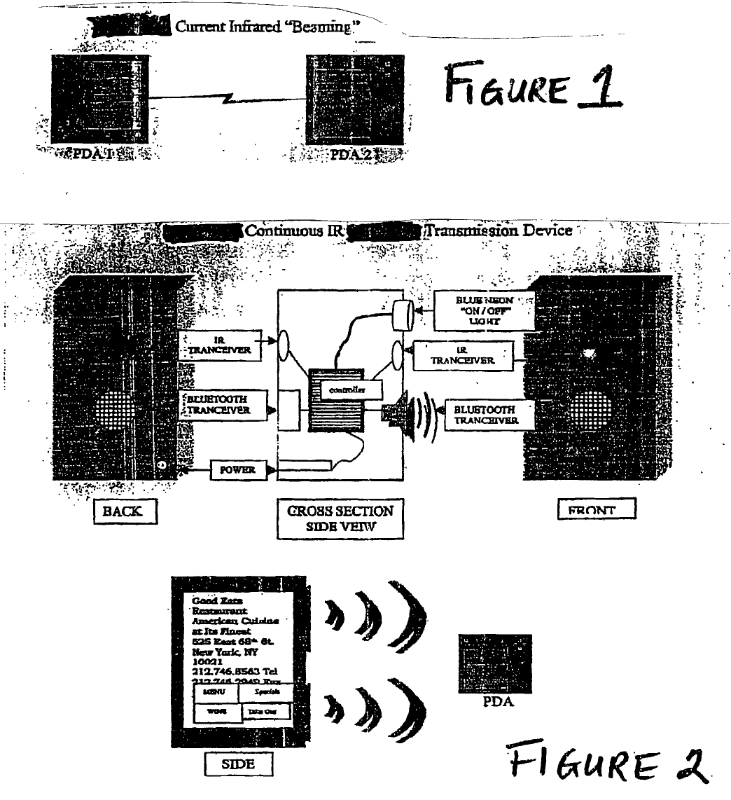

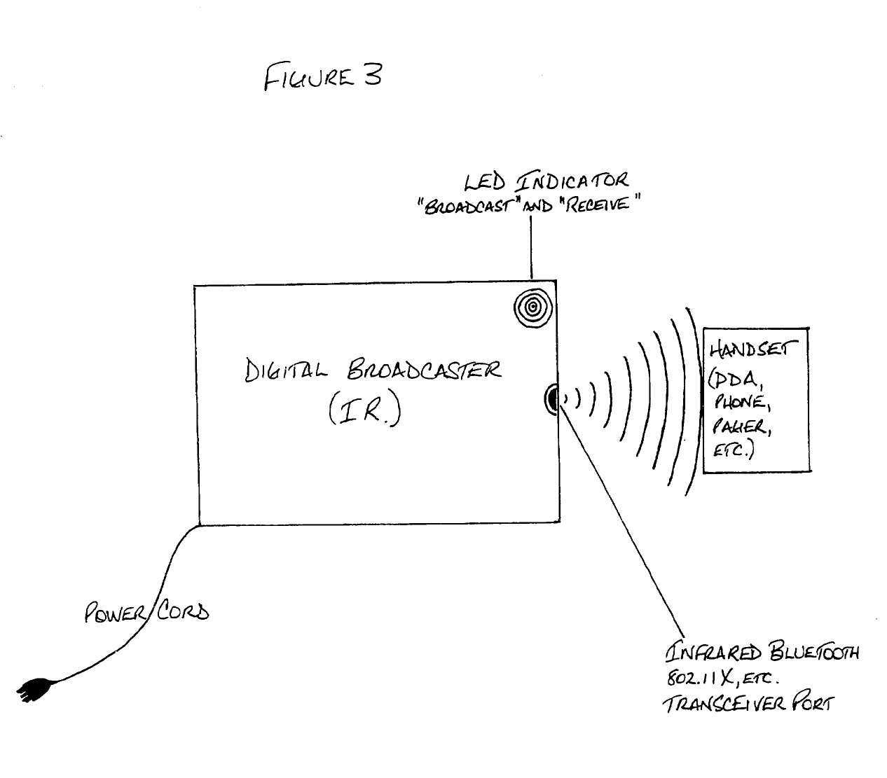

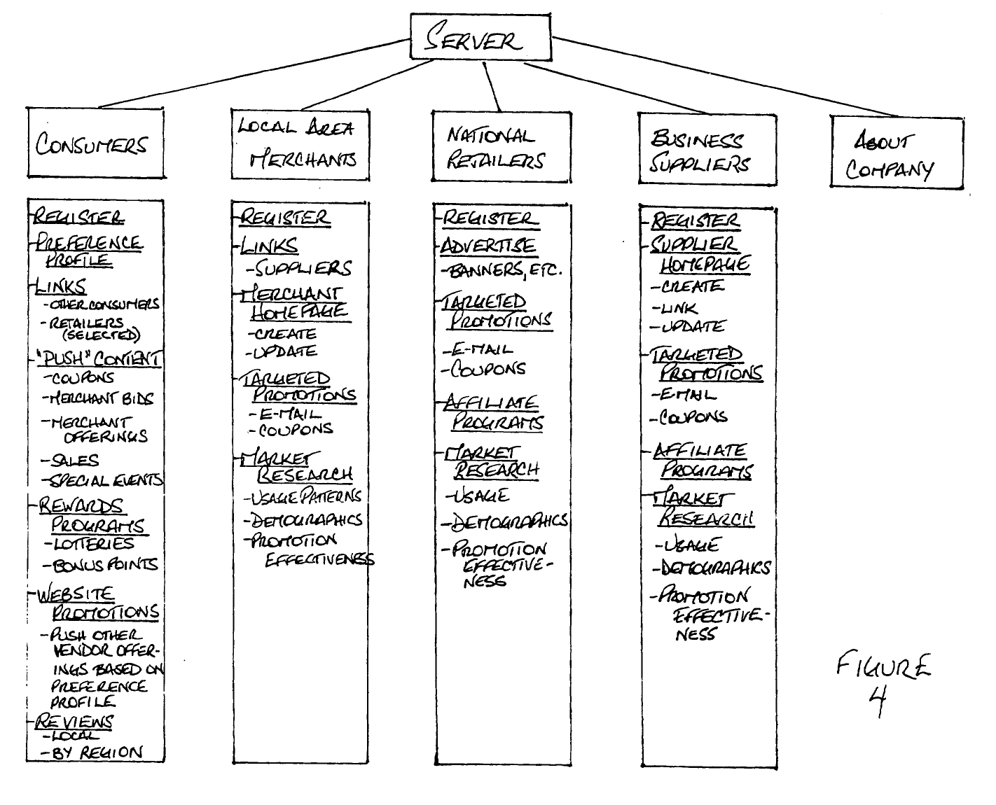

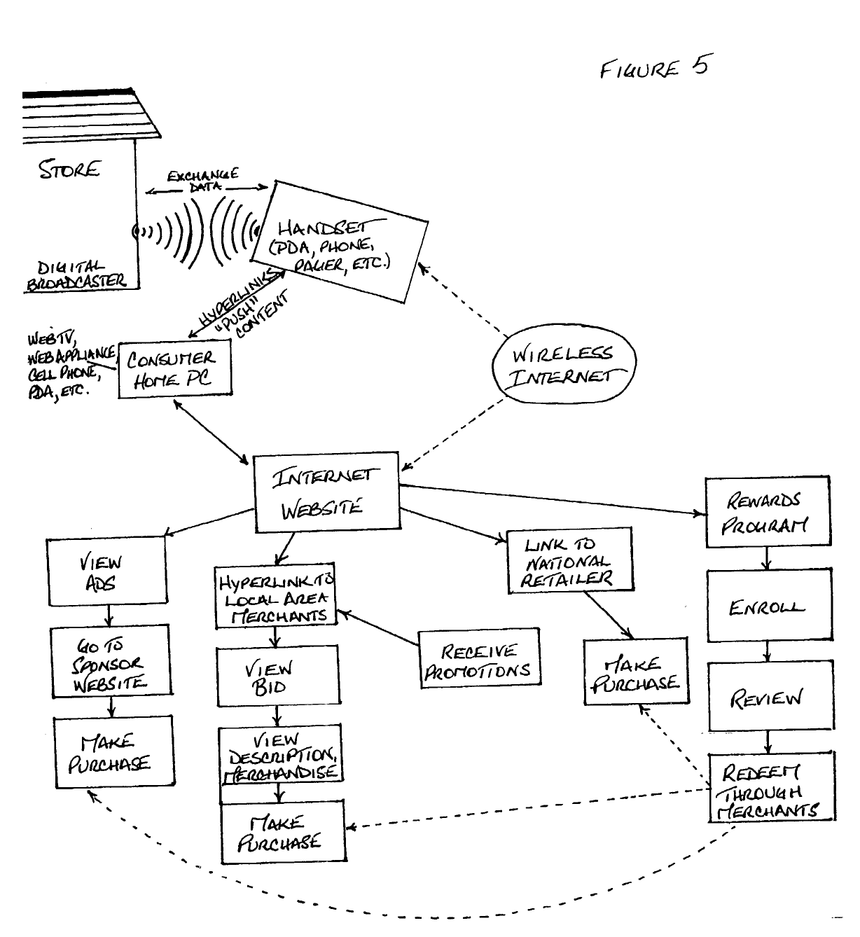

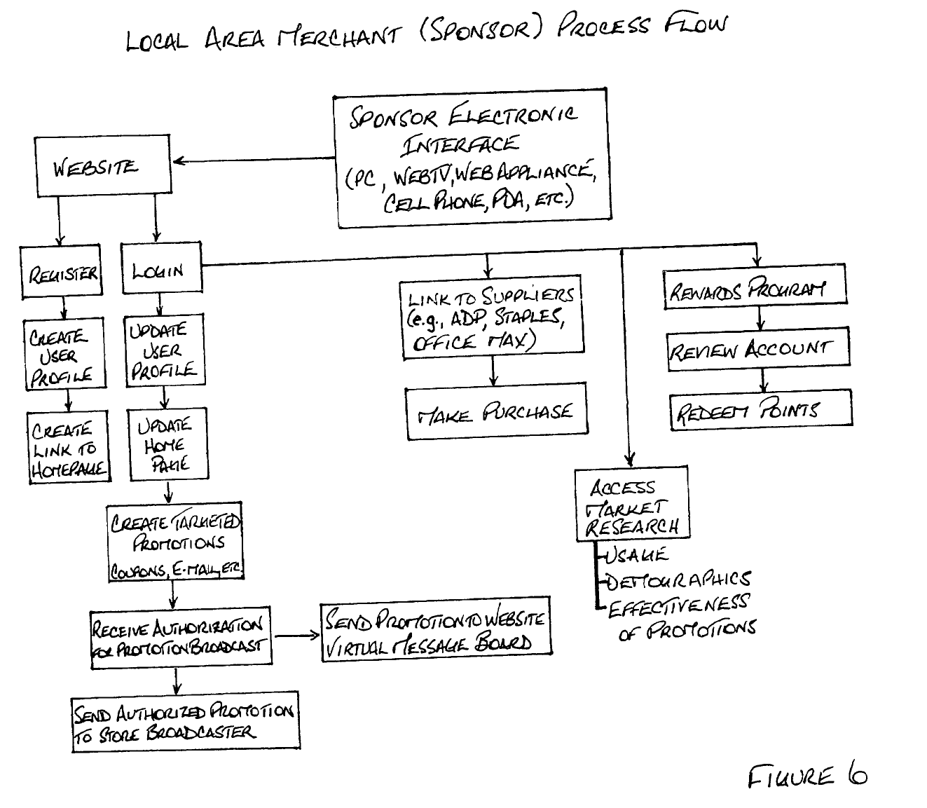

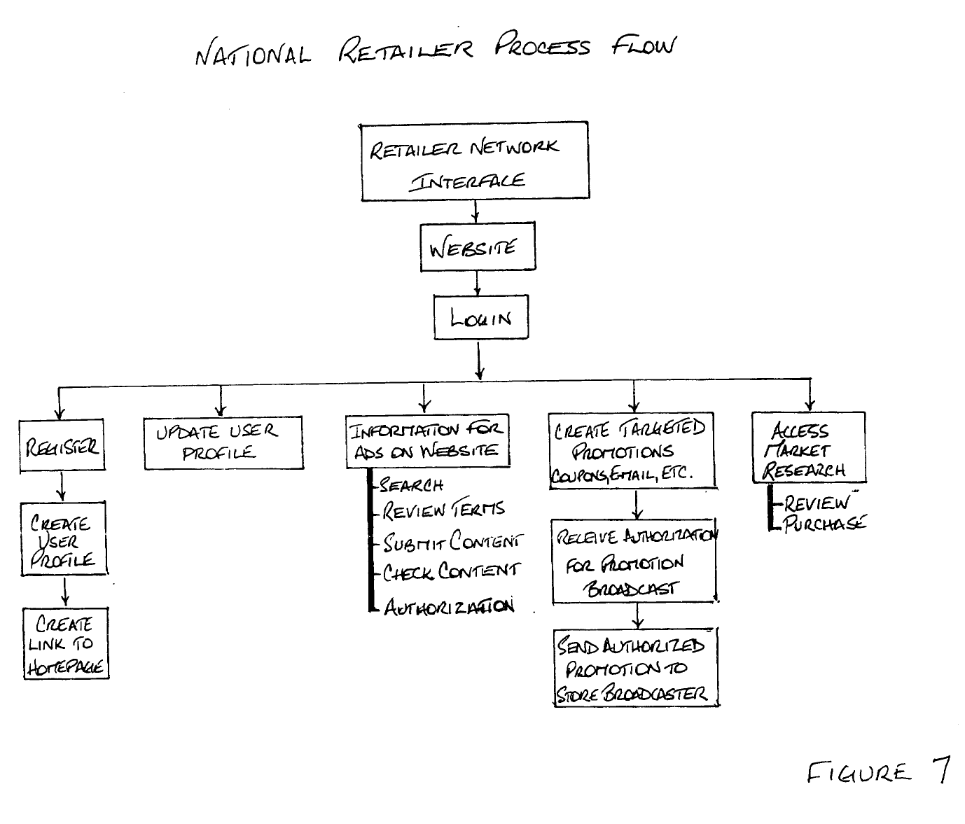

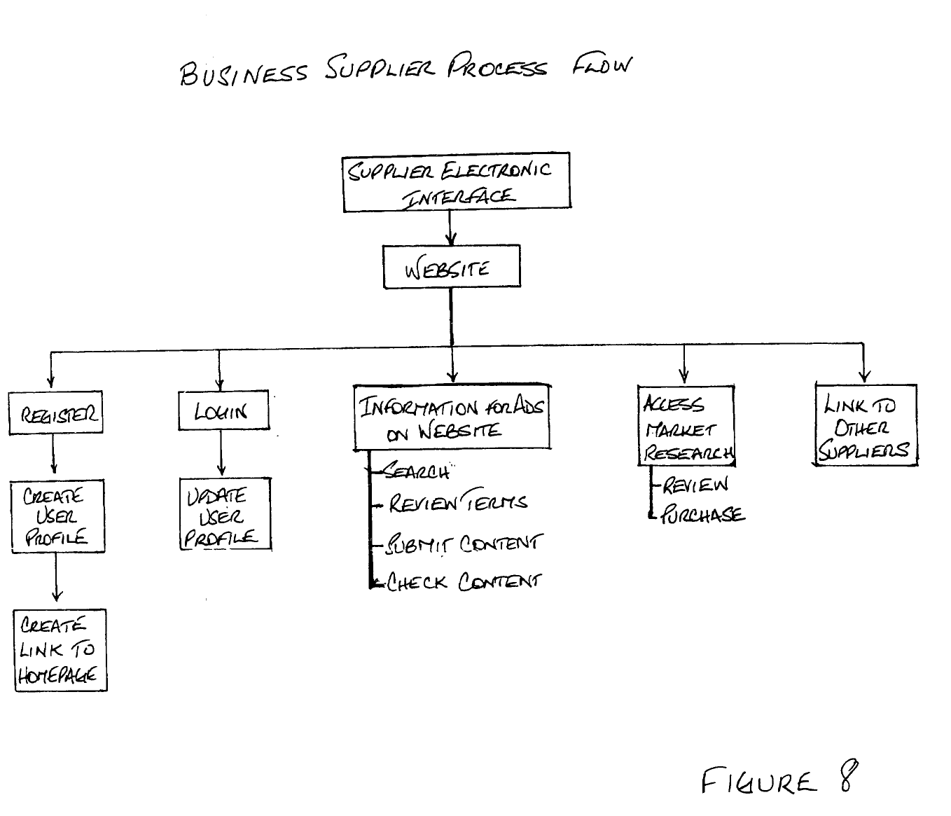

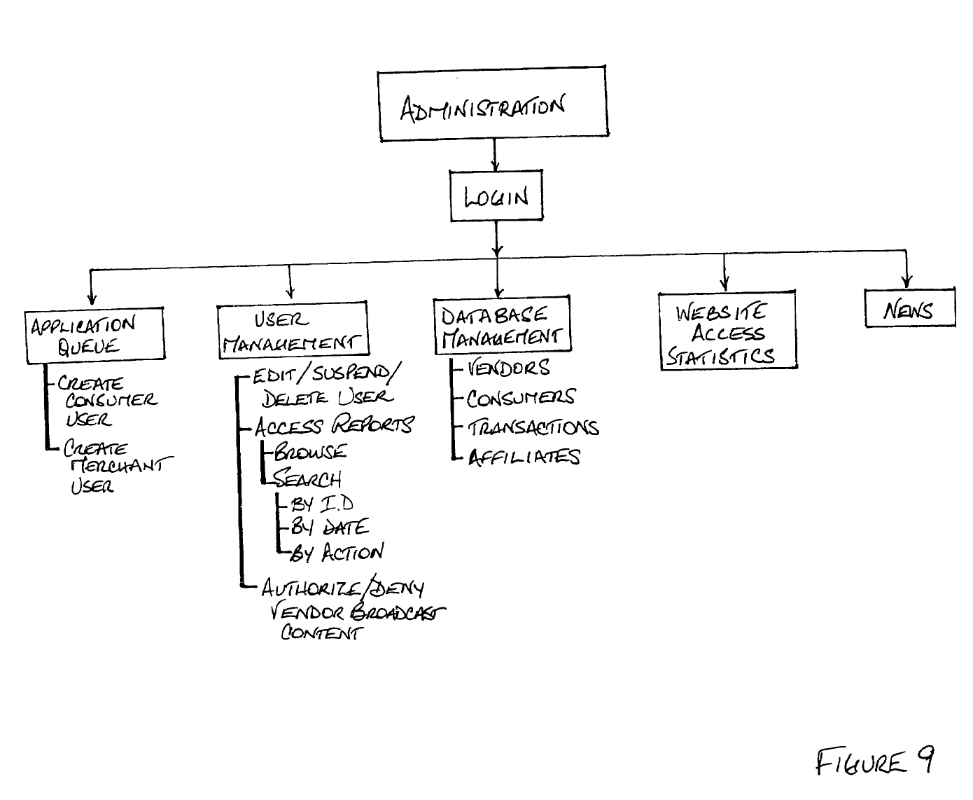

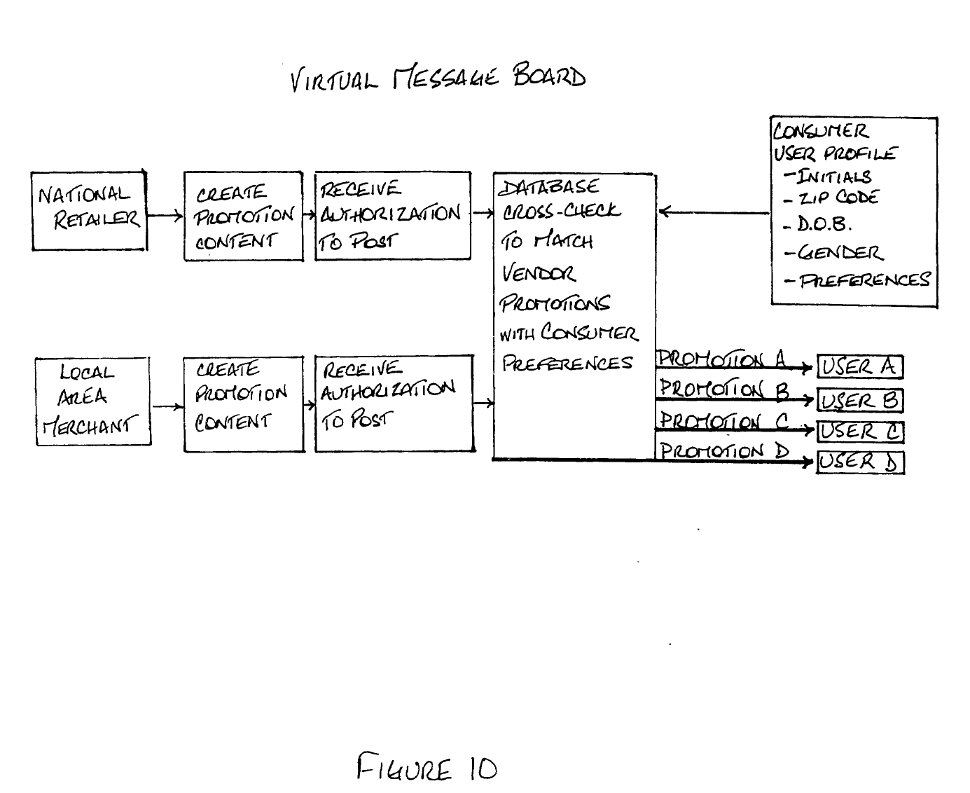

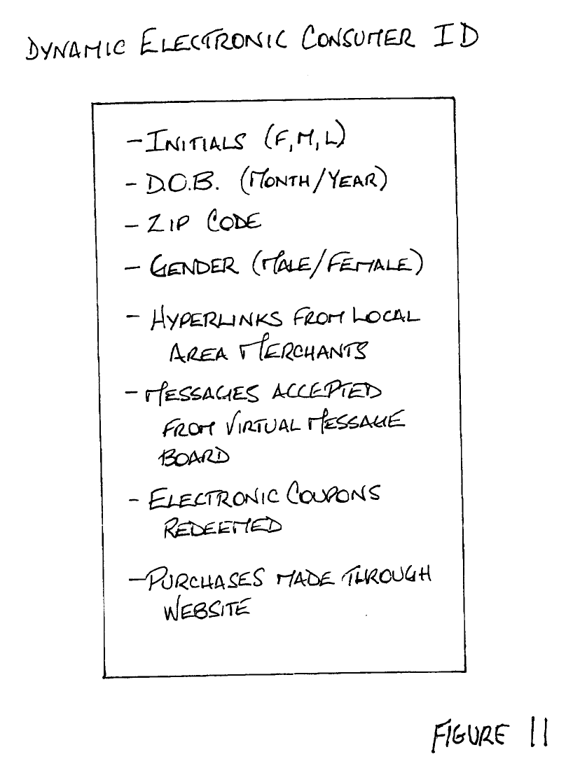

### DETAILED DESCRIPTION OF THE INVENTION

In accordance with the present invention a wireless device for broadcast of information is provided comprising:

a medium;

a means for storing information on said medium; and

a means for transmitting the information on said medium to various access points including a desktop personal computer, a handheld computer, a cellular phone or other mobile wireless devices.

The wireless device further comprises a means for storing, accessing and/or managing the information; and a means for communicating between said mobile wireless device and the wireless device.

The invention also provides a method for broadcasting information from a wireless device by providing the wireless device which contains information; transmitting the information from the wireless device; and capturing of the information by a mobile wireless device.

The method further includes the step of storing, accessing and/or managing the information; and the step of connecting to an electronic network for utilization of the information.

In addition, the invention also provides a system for broadcasting information from a wireless device comprising:

a wireless device containing information;

a communication component that permits information to be stored, accessed and/or managed by a mobile wireless device.

The system includes an electronic network component wherein the information stored, accessed and/or managed by the mobile wireless device links to an electronic network. The electronic system provides automated wireless broadcast of commonly requested business information, e.g. store business cards, to consumers using Personal Digital Assistant devices (PDAs) and for linking those particular consumers to that specific business on the Internet at some later time.

Numerous PDA and web enabled cell phone users possess portable technology that help them access, store and manage digital information for personal use. Current methods enable “hot syncing” of PDA's to desktop computers with Internet connections through which consumers can arrange portable access to information from resources across the world. What these mobile devices do not enable, however, is access to digital information from sources right in front of them. For example, a PDA user walking down Madison Avenue in Manhattan cannot get any information on her PDA about the antique jewelry boutique she just walked into. She could take a business card or flyer, but these are easily lost, quickly discarded, not easily entered into the mobile devices, very limited in the amount of information and perhaps even out of date. By transmitting an electronic version of these materials to the consumer's PDA, a merchant can leave a more lasting and useful impression upon the customer and can establish a link directly to the merchant's website.

To date, small business owners have found little reason to incorporate the Internet into everyday business. Approximately ninety percent of 24 million US companies have fewer than 100 employees. Many of these small businesses as well as public institutions have not, and likely will not in the near future, incorporate computer systems into the “front end” of their establishments. Reasons for this include expense, staff lack of familiarity with technology, process flow issues and the perception that these systems offer little value for customers. Recent surveys by the Small Business Administration indicate that less than 35% of small businesses employ a company website. By creating a simple to use digital broadcast system through wich merchants can directly interact with customers and pertinent potential customers (as opposed to millions of irrelevant “potential” customers in cyberspace), they can realized immediate improvements in customer relationship management and immediate reductions in advertising and promotional costs.

Recently, the popularity of information sharing between devices has skyrocketed as numerous useful software applications have become available and as the device users discover the case with which information can be transferred. Infrared “beaming” capabilities of most current devices enable PDA users to quickly and easily exchange small digital packets of text, graphics and sound for permanent storage and use. FIG. 1 illustrates current infrared beaming.

Most beaming, however, occurs on a single user to single user basis. Because of the need for the sender to select information for each transmission and the need to aim the PDA directly at the receiving device, this method precludes easy dissemination of multiple information packets and dissemination to multiple recipients simultaneously.

New developments in wireless technology, specifically radio frequency capabilities, are enabling short range (i.e. 30 feet) transmission of digital information to a myriad of electronic devices including cell phones, PDA's, computers, fax machines, and others.

The system of the invention can emit information packets automatically over a broader physical space and mass dissemination of information is made more efficient. For example, in one application, a restaurant owner uses this systeme to broadcast to passers by such information as business name, type of cuisine, address, phone and fax numbers, hours of operation, a complete menu and specials of the day. The pedestrian with a PDA simply points the PDA at the transmitting device and captures all this information in two to three seconds. The information would then be stored on the PDA in a list of favorite places for reference at a later date, e.g. when ordering for home delivery. The PDA user could “hot sync” the device to a personal computer, a hyperlink would be available to the business's website so that the consumer could access additional information such as special offers, coupons, a reservations system, a take out or delivery order system, patron reviews, customized messages or whatever else the restaurant owner cares to feature on the site.

Alternatively, the if the passerby decides to enter the restaurant and dine there, the transmitter could be used as a high tech, novel, cost-effective way to have patrons view the menu, specials, the wine list, etc. The digital transmission can include text, graphics, logos, video clips and sound files.

The inventions provision of opportunities for digital information broadcasting to PDA's/cell phones replaces paper menus, schedules, pamphlets, etc and automates repetitive tasks for information requests and to reach customers in a novel, cost-effective and unobtrusive way for advertising and customer relationship management.

The invention includes four basic components. These include, first an IR/RF Broadcast unit for the merchant's storefront. In a preferred embodiment this would be the size of a credit card and applied to the storefront window or door, if applicable, adjacent to credit card signs for American Express, Visa or Mastercard. The device is capable of transmitting a signal through the glass storefront to the street as well as backward to the interior of the store. Pedestrians recognizing the device by a distinctive logo, could choose to download information about the store to their PDA's. A merchant could update the content on the broadcast unit as often as desired.

The second component comprises a software application for use on a Palm device or personal computer that enables initial registration and coding by a representative of the company displaying the device.

The third component comprises a software application loaded onto the consumer's PDA in order to receive, catalogue, customize, prioritize, access and exchange information broadcast and disseminated by the company displaying the device.

Finally, the fourth component is a website that provides value added information and services to its online community of local are consumers and local area merchants and can aggregate this online community for existing Internet merchants. For instance, the local area merchants can now become customers themselves of an online procurement, payroll, or other business service. Information can be customized to consumer users based on a unique user identifier that maybe comprised of zip code, gender, initials, and date of birth or any other unique identifier.

Consumers may remain anonymous, and do not have to divulge name, address, phone, social security number to participate in the inventions interactive digital marketplace. The unique user identifier instructs the website to display information specific to the user's local area or the specific area desired. It provides the customer with reviews of establishments, neighborhood favorites, perks for frequent users, links to popular Internet merchants and more. Services for merchants include website development and and hosting for those not having their own site.

PDA's that can be used in the invention system include standard PDA's with infrared or radio frequency capability, capable of receiving transmissions from the broadcast device. The standard PDA can interact with the system without any additional hardware. Additional software downloads onto the PDA are optional and may be required for premium services such as file sorters, preferences, links, order forms, templates, etc. These downloads may be accessible from various websites or even directly from the broadcast devices themselves.

The pedestrian PDA users are able to readily identify establishments offering the broadcast service preferably by a visual key such as a neon light or logo displayed in the entrance of the establishment. More preferably, when a PDA user connects to the device there is some “reaction” by the transmitter. For example, a neon light on the transmitter could flash like a strobe light, change colors or transform in some other way.

The decision to receive broadcast data is left to the discretion of the PDA user. An optional feature of the invention includes a display screen so that the consumer may make an informed decision about the value of content. Otherwise, the consumer simply accepts the transmission for viewing on the PDA device.

The system incorporates file formats commonly in use with PDA devices including web browser systems on enabled cell phones. The lack of uniformity necessitates that the broadcast device emit multiple versions of the same information packet until a single standard is constructed. Incorporation of different formats are transparent to the user, so that they do not need to select a format but rather just enable their PDA for receiving.

To receive the infrared or radio frequency transmission from the broadcast device, PDA users are physically located a few feet away from the device so that multiple users can access broadcasts simultaneously without crowding each other. It would be preferable to receive transmissions from any direction so that a PDA user is not required to precisely align their device with the transmission port of the broadcast device. Some restriction on signal spread is required so that there is no “spill over” to an adjacent merchant's storefront. Although it is well recognized that atmospheric conditions can interfere with IR transmissions, a preferred feature of the invention system is one that enables broadcast transmission through a storefront window to a pedestrian on the sidewalk.

Each received file prompts the PDA user whether to accept the file in storage on their device. Each file may also prompt the PDA user to provide the broadcast device with reciprocal information, i.e. personal data, if the user so desires. An example includes when a vendor asks customers to enter contact information for a prize drawing or raffle.

Once downloaded the file is editable and easily stored and tracked on the PDA. Within the file are easy to use links that connect the PDA user to the sponsor's website either through a wireless connection or once the PDA user “syncs” the device to a desktop computer.

A hyperlink can be incorporated into the digital packet of information that is transmitted from the broadcast device to the PDA. The hyperlink enables the consumer to “hot sync” the PDA and immediately be connected to the community website which contains a link to the local area merchant.

In operating the broadcast system, the user establishment chooses a location for the device within the confines of their space. This may be in the storefront to cultivate new customers from passing by or it may be in a more central location within the establishment such as the music section of a department store where free music samples can be downloaded. The device is portable so that it can be easily moved when desired or when space requirements change. The device is designed so that it can be easily and safely displayed on a shelf overhead or suspended from ceiling brackets.

Preferably the power source to the device is supplied through a long life battery contained with the device housing. If battery performance or device power requirements do not permit this, standard AC wall outlets can be employed to power the device. No additional cables, phone lines or other wiring is required. Simply plugging in the power cored and turning on the switch enables the operator to begin system use.

Another optional feature of the broadcast device is to program the device with static information that rarely changes, for example business name, address, phone and fax numbers. Updates would require a new or different device.

Merchants desiring the capability to update their information periodically, the system can be devised to give the company final authority for updates. This helps prevent the insertion of viruses onto the broadcast device by rogue merchants or PDA users that could cause irreparable harm to the company.

Updates by the merchant can be done by visiting the website, entering new information, receiving an authorization code and then loading the update onto the broadcaster through a PC or PDA that itself can beam the code to the broadcast device. Messages can be created entirely by the merchant or can be constructed based on pre-formatted templates such as menus, store profiles, job postings, merchandise descriptions, etc.

Once the message content on the broadcast device is complete, broadcasting commences automatically with messages being beamed continuously in a repeating loop so that they are available at any moment to any PDA user within the vicinity of the device. When multiple messages are available through the same broadcaster, PDA users must be able to choose from the selection rather than having to receive all files just to get the one or two they want. Tracking mechanisms can be used to help the merchant identify the volume, time and other characteristics of the messages downloaded.

If the PDA users agree to submit information to the establishment for the purpose of compiling email lists, contests, suggestions, complaints, etc, the apparatus is enabled to accept the messages and store them in a format that is easily accessed and manipulated by the broadcast merchant.

All functions of the invention system are capable of being integrated into a central server facility (on the Internet) for storage, tracking, searching, sharing of data and for integration with existing web content.

The broadcast device itself is capable of incorporating modular components for the new hardware and software upgrades

The invention now being fully described, it will be apparent to one of ordinary skill in the art that many changes and modifications can be made thereto without departing from the spirit or scope of the invention as set forth herein.

What is claimed is:

1. A wireless device for broadcast of information comprising:
a medium;
a means for storing information on said medium; and
a means for transmitting the information on said medium to various access points including a desktop personal computer, a handheld computer, a cellular phone or other mobile wireless devices.

2. The wireless device as defined in claim 1, further comprising a means for storing, accessing and/or managing the information.

3. The wireless device as defined in claim 1, further comprising a means for communicating between said mobile wireless device and the wireless device.

4. A method for broadcasting information from a wireless device comprising the steps of;
providing a wireless device containing information;
transmitting the information from said wireless device;
capturing of the information by a mobile wireless device.

5. The method as defined in claim 4, comprising the further step of storing, accessing and/or managing the information.

6. The method as defined in claim 4, comprising the further step of connecting to an electronic network for utilization of the information.

7. A system for broadcasting information from a wireless device comprising:
a wireless device containing information;
a communication component that permits information to be stored, accessed and/or managed by a mobile wireless device.

8. The system according to claim 7, further comprising an electronic network component wherein the information stored, accessed and/or managed by the mobile wireless device links to an electronic network.
